(19) United States
(12) Patent Application Publication
(10) Pub. No.: US 2001/0051591 A1
(43) Pub. Date: Dec. 13, 2001

(54) Safening crops from the phytotoxic effects of herbicidally active N-phosphonomethyl-glycines

(76) Inventors: Richard E. Ferrett, St. Joseph, IL (US); David W. Keifer, Skillman, NJ (US)

Correspondence Address: FMC Corporation, Patent Administrator, 1735 Market Street, Philadelphia, PA, 19103, US

(21) Appl. No.: 09/825,002

(22) Filed: Apr. 3, 2001

Related U.S. Application Data
(60) Provisional application No. 60/225,899, filed on Aug. 17, 2000.
(60) Provisional application No. 60/196,708, filed on Apr. 13, 2000.

(51) Int. Cl. A01N 25/00; A01N 55/02; A01N 57/00; A01N 25/32

(52) U.S. Cl. 504/103; 504/116.1; 504/126; 504/127

(57) ABSTRACT

The present invention is directed to a method of protecting a plant from phytotoxic injury from application to a locus thereof of a herbicidally effective amount of at least one N-phosphonomethyl-glycine. The method comprises applying to the locus of the plant the herbicidally effective amount of the N-phosphonomethyl-glycine and prior thereto, together therewith, or subsequent thereto, applying to the locus a safening amount of at least one salt. The present invention is also directed to herbicidal compositions containing such N-phosphonomethyl-glycine and salt(s).

### FIELD OF THE INVENTION

The present invention relates to the field of controlling unwanted plant species in agriculture. In particular, the present invention relates to compositions and methods for safening crops subjected to a class of herbicidally active compounds commonly known as “N-phosphonomethyl-glycines” and any of its salts, acids, amides, esters, thioesters and linear and cyclic anhydrides.

### BACKGROUND OF THE INVENTION

Herbicides are useful for controlling unwanted vegetation, i.e., weeds, which may otherwise cause significant damage to crops. For crop protection, so-called “selective” herbicides are desired that control weeds without damaging the crop to any significant degree. Such crops are said to exhibit tolerance to the herbicide.

N-phosphonomethyl-glycines, e.g., glyphosate, are valuable herbicides, but are not particularly selective in their application as herbicides. One approach to safening such herbicides has been to use glyphosate, sold as a formulation of the active ingredient, under the name and trademark ROUNDUP® Herbicide, and ROUNDUP® Ultra Herbicide, in conjunction with genetically-modified seed lines that have tolerance to such non-selective herbicides. Unfortunately, high technology costs, as well as the discomfort of many consumers to the introduction of such genetically modified crops to the market, has pressured the commercial viability of this approach.

Others have described a method for reducing the phytotoxicity of such N-phosphonomethyl-glycines to crops such as soybeans by adding 4-trifluoromethyl-4-nitrodiphenyl ether (also known as “acifluorfen”) thereto; e.g., see WO 96/15674.

### SUMMARY OF THE INVENTION

An object of this invention is to decrease the phtyotoxicity of N-phosphonomethyl-glycines against valuable agricultural crops.

The present invention is directed to a method of protecting a plant from phytotoxic injury from application to a locus thereof of a herbicidally effective amount of at least one N-phosphonomethyl-glycine, which method comprises applying to the locus of the plant the herbicidally effective amount of the N-phosphonomethyl-glycine and prior thereto, together therewith, or subsequent thereto, applying to the locus a safening amount of at least one salt. The present invention is also directed to herbicidal compositions containing such N-phosphonomethyl-glycines and salt(s).

An important benefit of the present invention is the safening of non-genetically engineered plants, e.g., soybeans, to N-phosphonomethyl-glycines, e.g., glyphosate.

### DETAILED DESCRIPTION OF THE INVENTION

The herbicidally active N-phosphonomethyl-glycines known in the art, including any of its salts, acids, amides, esters, thioesters and linear and cyclic anhydrides, may be used in this invention. For example, N-phosphonomethyl-glycines are described in Franz, U.S. Pat. Nos. 3,799,758 and 3,977,860, and are represented by the following formula (I):

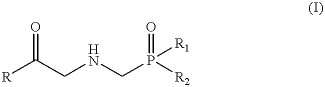

wherein R, R₁, and R₂ are independently selected from the group consisting of:

-halogen, —OH, —SH;

—NR₄R₅ wherein R₄ and R₅ are independently selected from the group consisting of hydrogen, alkyl and hydroxyalkyl having 1-4 carbon atoms, alkenyl having 2-4 carbon atoms, and R₄ and R₅ taken together with the nitrogen atom form a heterocyclic ring;

—OR₃ and —SR₃, wherein R₃ is selected from the group consisting of monovalent hydrocarbon groups, monovalent hydrocarbonoxyhydrocarbon groups each containing 1-18 carbon atoms, halogenated monovalent hydrocarbon groups, halogenated monovalent hydrocarbonoxyhydrocarbon groups each containing 1-18 carbon atoms and from 1-3 halogen atoms;

—CₘH₂ₘNR₄R₅ groups wherein m is 1-4 and R₄ and R₅ are as above defined provided that no more than two R, R₁ or R₂ can be —NR₄R₅, —OR₃ or —SR₃; and

—OR₆ wherein R₆ is a salt-forming cation selected from the group consisting of cations of alkali metals, alkaline earth metals, copper, zinc, manganese, nickel, ammonium, organic ammonium, provided that when the organic group is aryl the ammonium salt is a primary amine salt, and mixtures of such salts, provided that when any one of R, R₁ or R₂ is halogen the others of R, R₁ or R₂ cannot be —OR₆, and further provided that no more than two of R, R₁ or R₂ are —OR₆ when R₆ is ammonium or organic ammonium.

These compounds, as well as the methods for preparation thereof, are incorporated herein by reference.

Preferred N-phosphonomethyl-glycines usable in this invention include glyphosate (wherein each of R, R₁ and R₂ is —OH) and any of its herbicidally active salts, acids, amides, esters, thioesters and linear and cyclic anhydrides, e.g., the trimethylsulfonium salt of glyphosate, the sodium sesqui salt of glyphosate and the isopropylamine salt of glyphosate. Particularly preferred is the isopropylamine salt of glyphosate commonly available from the Monsanto Company of St. Louis, Mo., under the trademark ROUNDUP®.

The compositions and methods of this invention utilize a safening amount of at least one salt. It is believed that the cations of the salt in some manner prevent at least a phytotoxic amount of a N-phosphonomethyl-glycine from reaching the plant's site where phytotoxic action takes place, whether that site of action is on the surface of the plant or inside the plant, thereby safening that plant from phytotoxic injury. Salts useful in the context of the present invention are any salt, or a combination of salts, that can provide the cations necessary for safening a plant from phytotoxic injury caused by at least one N-phosphonomethyl-glycine when the salt is applied to a locus of a plant for which safening is desired. Salts wherein the cation is aluminum, boron, calcium, iron, magnesium, potassium, sodium or zinc are preferred. The anion, which together with a plant safening cation forms a plant safening salt, is thought to be of secondary importance in safening a plant. Useful anions for forming plant safening salts with plant safening cations include, without limitation, the anions of halide (C1, Br, F, I), acetate, adipate, anisate, acrylate, ascorbate, benzoate, bromate, bromite, C₁-C₂₀ straight or branched chain optionally substituted alkanoates, carbonate, bicarbonate, chlorate, chlorite, chromate, citrate, dichromate, cinnamate, cyclamate, diphosphonate, formate, fulminate, fumarate, gallate, glutarate, glycolate, gluconate, glutamate, hydroxy, hydroxybenzoate, iodate, iodite, lactate, levulinate, malonate, nitrate, nitrite, oleate, oxalate, hydrogenoxalate, phosphinate, phosphonate, phosphite, phosphate, orthophosphate, metaphosphate, dihydrogenphosphate, hydrogenphosphate, diphosphate, pyruvate, phthalate, salicylate, aminosalicylate, acetylsalicylate, sulfate, bisulfate, sulfite, bisulfite, tartrate, hydrogentartrate, thioacetate, vanillate, as well as other anions.

Preferred salts are calcium chloride, sodium chloride, potassium chloride, calcium nitrate, sodium nitrate, potassium nitrate, sodium sulfate, aluminum sulfate, ferrous sulfate, magnesium chloride, magnesium sulfate, zinc sulfate, sodium carbonate, sodium bicarbonate, and mixtures thereof. Particularly preferred are calcium chloride, magnesium chloride, aluminum sulfate, sodium nitrate, and mixtures thereof.

The at least one salt is either an organic salt or an inorganic salt that can be soluble, soluble to some degree, or insoluble in water. The term “soluble” or “solubility” refers to the ability or tendency of one substance to blend uniformly with another, e.g., a salt in water. Salts can vary in their degree of solubility in water, depending on, inter alia, the chemical nature of the salt, amount of salt per volume of water, temperature, and pressure. Hence, for the purposes of the present invention, a “water-soluble salt” that can be used is a salt that is sufficiently soluble in water to provide a solution of the salt dissociated into its cationic and anionic form, whereby the salt cations safen a plant from phytotoxic injury caused by at least one N-phosphonomethyl-glycine when the salt solution is applied to a locus of a plant for which safening is desired. One method for expressing solubility of a salt in water is a ratio of weight of salt that is soluble in water to weight of water. For example, where a water-soluble salt is desired, a useful plant safening solution of salt in water is in the ratio range of from about 0.00005 pounds of salt/pound of water to about 0.25 pounds of salt/pound of water.

Other herbicidally effective compounds may be mixed with the N-phosphonomethyl-glycines and salts of this invention. For example, COMMAND®3ME herbicide (available from FMC Corporation, Philadelphia, Pa.) contains clomazone, 2-(2-chlorophenyl)methyl-4,4-dimethyl-3-isoxazolinone (a highly effective herbicide covered by U.S. Pat. No. 4,405,357 and assigned to FMC Corporation, Philadelphia, Pa.) and a safening amount of calcium chloride. Without limitation, other herbicides which can be included are (2,4-dichlorophenoxy)acetic acid (2,4-D), (4-chloro-2-methylphenoxy)acetic acid (MCPA), (+/−)-2-(4chloro-2-methylphenoxy)propanoic acid (MCPP), isoproturon, imazapyr, imazamethabenz, imazethapyr, imazaquin, bifenox, fomasafen, ioxynil, bromoxynil, chlorimuron, achlorsulfuron, bensulfuron, pyrazosulfuron, triasulfuron, fenoxaprop, fluazifop, quizalofop, diclofop, bentazone, butachlor, metolachlor, acetochlor, dimethenamide, clomazone, sulfentrazone, carfentrazone ethyl, dicamba, fluroxypyr, sulcotrione, mesotrione, isoxaflutole, triclopyr, as well as any other herbicides known in the art.

As set forth herein, the terms “crop”, “crops”, “plant”, or “plants” encompasses a considerable number of individual plant species. Hence, there are a number of plants that are expected to be safened or made more tolerant to the phytotoxic characteristics of N-phosphonomethyl-glycines by the method of applying the at least one salt of this invention to a locus of these plants. These plants preferably include, without limitation, soybean, cotton, sugarbeet, rape (also known as canola), potato, sunflower, cucumber, pinto bean, tomato, peanut, lettuce, carrot, sweet potato, alfalfa, tobacco, corn (also known as maize), rice, sorghum, wheat, barley, oats, rye, triticale, sugarcane, dried bean, pea and other crops. More preferred plants on which to apply the compositions of the present invention are soybean, cucumber, pinto bean, tomato, sorghum, rape, cotton, sugarbeet, potato, sunflower, peanut, lettuce, carrot, sweet potato, alfalfa, dried bean, pea, corn, rice, wheat, and tobacco. The most preferred plant to which the present invention is applied is soybean.

The safening amount of the salt that may be applied to the locus may vary depending on the specific salt used and the amount of N-phosphonomethyl-glycines, e.g., glyphosate, to be used. In general, the ratio of the amount of the N-phosphonomethyl-glycines, e.g., glyphosate, to the safening amount of the salt, may be in the range of 1:0.01-1:100, preferably, 1:0.04-1:20, more preferably, 1:0.17-1:5, respectively. As mentioned herein, calcium chloride is a preferred salt within the scope of this invention. In general, the ratio of the amount of N-phosphonomethyl-glycines, e.g., glyphosate, to the safening amount of calcium chloride may be in the range of 1:0.01-1:20, preferably, 1:0.04-1:10, more preferably, 1:0.17-1:2.5, respectively.

In methods of applying the N-phosphonomethyl-glycines and, for example, COMMAND® 3ME microencapsulated clomazone herbicide where the safening effect on crops is desired, the herbicidally effective N-phosphonomethyl-glycines may be applied to the locus of the plant in an amount of about 0.01 to about 4 kilograms active ingredient/hectare. The amount of the COMMAND® 3ME microencapsulated clomazone herbicide comprised of one or more crop safening salts is applied to the same locus in an amount of from about 0.001 to about 3 kilograms clomazone/hectare. At the lower concentrations of application, the COMMAND® 3ME microencapsulated clomazone herbicide generally has no phytotoxic effect; however, at the higher concentrations, the COMMAND® 3ME microencapsulated clomazone herbicide may itself be phytotoxic, but preferably not to plants of interest. More preferably, the amount of the N-phosphonomethyl-glycine is about 0.07 to about 2 kilograms active ingredient/hectare, and the amount of the COMMAND® 3ME microencapsulated clomazone herbicide is about 0.02 to about 2 kilogram clomazone/hectare. Most preferably, the amount of the N-phosphonomethyl-glycine is about 0.2 to about 1 kilogram active ingredient/hectare, and the amount of the COMMAND® 3ME microencapsulated clomazone herbicide is about 0.05 to about 1.38 kilogram clomazone/hectare.

In the context of the present invention, methods of application of N-phosphonomethyl-glycine and the safening amount of the at least one salt include those wherein the N-phosphonomethyl-glycine is applied to a locus of the plant independently with respect to application of the at least one salt.

The N-phosphonomethyl-glycine may be applied prior to application of the salt to the locus. It is expected that safening of plants to the phytotoxic effects of the N-phosphonomethyl-glycine would result by subsequent application of the salt. Alternatively, the salt may be applied prior to the N-phosphonomethyl-glycine to the locus.

In an additional alternative method, the N-phosphonomethyl-glycine may be applied in admixture with the salt. This is a particularly preferred method. When the N-phosphonomethyl-glycine is applied in admixture with the salt, the individual compounds and compositions are mixed together and applied in one application to the locus of the plant, or to a locus where the plant is to be planted. An effective admixture of N-phosphonomethyl-glycine and the salt is prepared independent of the order in which the two are combined, and can be prepared at any time prior to application of the admixture. Preferably, the mixture of the two is applied as a tank mix wherein the admixture is prepared immediately prior to the time of application to said locus.

The N-phosphonomethyl-glycines of the present invention may be formulated in any conventional form using any conventionally available adjuvants and carriers.

For example, for agricultural use, the N-phosphonomethyl-glycines may be formulated as water-soluble or water-dispersible granules, as wettable powders, as emulsifiable concentrates, as flowable suspensions, as microencapsulated formulations, as solutions, or as any of other known types of agriculturally-useful formulations, depending on the desired mode of application.

The N-phosphonomethyl-glycines may be applied as water-diluted sprays to the areas in which suppression of vegetation is desired. These formulations may contain as little as 0.1%, 0.2% or 0.5% to as much as 95% or more by weight of active ingredient.

Wettable powders are in the form of finely divided particles which disperse readily in water or other dispersant. The wettable powder is ultimately applied to the soil either as a dry dust or as an emulsion in water or other liquid. Typical carriers for wettable powders include Fuller's earth, kaolin clays, silicas, and other highly absorbent, readily wet inorganic carriers. Wettable powders normally are prepared to contain about 5-80% of active ingredient, depending on the absorbency of the carrier, and usually also contain a small amount of a wetting, dispersing or emulsifying agent to facilitate dispersion. For example, a useful wettable powder formulation contains 80.0 parts of the N-phosphonomethyl-glycines, 17.9 parts of Palmetto clay, and 1.0 part of sodium lignosulfonate and 0.3 part of sulfonated aliphatic polyester as wetting agents. Additional wetting agent and/or oil will frequently be added to the tank mix for postemergence application to facilitate dispersion on the foliage and absorption by the plant.

Other useful formulations for the N-phosphonomethyl-glycines are emulsifiable concentrates (ECs) which are homogeneous liquid compositions dispersible in water or other dispersant, and may consist entirely of the N-phosphonomethyl-glycines and a liquid or solid emulsifying agent, or may also contain a liquid carrier, such as xylene, heavy aromatic naphthas, isphorone, or other non-volatile organic solvents. For herbicidal application these concentrates are dispersed in water or other liquid carrier and normally applied as a spray to the area to be treated. The percentage by weight of the N-phosphonomethyl-glycines may vary according to the manner in which the composition is to be applied, but in general comprises 0.5 to 95% of the N-phosphonomethyl-glycines by weight of the herbicidal composition.

Flowable formulations are similar to ECs except that the N-phosphonomethyl-glycines are suspended in a liquid carrier, generally water. Flowables, like ECs, may include a small amount of a surfactant, and will typically contain active ingredients in the range of 0.5 to 95%, frequently from 10 to 50%, by weight of the composition. For application, flowables may be diluted in water or other liquid vehicle, and are normally applied as a spray to the area to be treated.

Microencapsulated formulations containing the N-phosphonomethyl-glycines consist of envelopments of small particles of toxicant which, without limitation, promote prolonged activity, and reduce mammalian toxicity, volatilization losses, environmental degradation, and soil movement. Microcapsules may be prepared by interfacial or in-situ polymerization by emulsifying an aqueous phase containing one or more emulsifiers and a water-immiscible phase containing the N-phosphonomethyl-glycines, an isocyanate, and an optional hydrocarbon solvent; agitating the emulsion while adding thereto an aqueous solution of at least one polyfunctional amine; and curing the microcapsules by continuing the agitation while warming. Typical polyfunctional amines include without limitation, ethylenediamine, diethyltriamine, triethylenetetramine, and 1,6-hexanedamine. For application, microcapsules may be diluted in water or other liquid vehicle, and are normally applied as a spray to the area to be treated.

Typical wetting, dispersing or emulsifying agents used in agricultural formulations include without limitation, the alkyl and alkylaryl sulfonates and sulfates and their sodium salts; alkylaryl polyether alcohols; sulfated higher alcohols; polyethylene oxides; sulfonated animal and vegetable oils; sulfonated petroleum oils; fatty acid esters of polyhydric alcohols and the ethylene oxide addition products of such esters; and the addition product of long-chain mercaptans and ethylene oxide. Many other types of useful surface-active agents are available in commerce. Surface-active agents, when used, normally comprise 1 to 15% by weight of the composition.

Other useful formulations for the N-phosphonomethyl-glycines include suspensions of the active ingredient in a relatively non-volatile carrier such as water, corn oil, kerosene, propylene glycol, or other suitable solvents.

Still other useful formulations for herbicidal applications of the N-phosphonomethyl-glycines include simple solutions of the active ingredient in a solvent in which such is completely soluble at the desired concentration, such as water, acetone, alkylated naphthalenes, xylene, or other organic solvents.

Pressurized sprays, typically aerosols wherein the N-phosphonomethyl-glycines are dispersed in finely divided form as a result of vaporization of a low-boiling dispersant solvent carrier may also be used. Water-soluble or water-dispersible granules are free-flowing, non-dusty, and readily water-soluble or water-miscible. The soluble or dispersible granular formulations described in U.S. Pat. No. 3,920,442 are useful herein with the N-phosphonomethyl-glycines. In use by the farmer on the field, dispersable granular formulations, emulsifiable concentrates, wettable powders, flowable concentrates, solutions, etc., may be diluted with water to give a concentration of active ingredient in the range of about 0.01% or 0.05% to 3% or 4%.

The adjective “about” is used herein to indicate that certain preferred operating ranges, such as ranges for rates of application of herbicides to the locus where herbicidal control is desired, are not fixedly determined. The meaning will often be apparent to one of ordinary skill. For example, a recitation of a rate of application of herbicide of about 0.01 kg/ha to about 4 kg/ha would be interpreted to include other like rates of application of herbicide that can be expected to favor control of weed species, such as, for example, 0.005 kg/ha and 5 kg/ha. Where guidance from the experience of those of ordinary skill is lacking, guidance from the context is lacking, and where a more specific rule is not recited below, the “about” range shall be not more than 20% of the absolute value of an end point or 20% of the range recited, whichever is less.

As used herein, the terms “crop”, “crops”, “plant” or “plants” are one and the same, and refer to plants of interest or plant products derived thereof that are grown for ornamental, industrial or food uses. The term “phytotoxic injury” as used herein means unintended herbicidal effect on a plant of interest resulting in significant damage to the plant. The term “weed” refers to an unwanted plant that is growing in a place or in a manner that is detrimental to a plant of interest. The term “weed control” refers to significant damage, caused by, for example, a herbicide, to the bulk of the weeds wherein said weeds are either dead or dying, thereby not competing with crops for subsistence. The term “safening” refers to the ability to protect a plant of interest from significant phytotoxic injury due to herbicide treatment.

The following examples further illustrate the present invention, but, of course, should not be construed as in any way limiting its scope. The examples set forth certain biological data illustrating the efficacy of the methods of the present invention in safening plants. Unless otherwise indicated, all parts, percentages, and the like, are by weight.

### EXAMPLE 1

### Safening of Soybeans From The Phytotoxic Effects Of The Herbicidal Compound Glyphosate

Glyphosate, tested as ROUNDUP® Ultra Herbicide (termed in Examples 1-3 as “Herbicidal Compound”), and COMMAND® 3 ME Herbicide comprised of at least one plant-safening, inorganic, water-soluble salt (calcium chloride), termed in Examples 1 and 2 as “Safening Composition A”, were tested as water solutions on two soybean varieties (Asgrow 2704 and Asgrow 3134). The aforementioned solutions were sprayed in admixture as a tank mix onto flats of 12-day-old soybean plants arranged in a randomized, block design. There were four replicates for each rate of application. The soybean plants were evaluated at 21 days after treatment for percent phytotoxic injury by comparison to tests conducted on untreated plants and plants treated with Herbicidal Compound only. The rate of application clomazone for the Safening Composition A, and the rate of application of glyphosate for the Herbicidal Compound are expressed below in kg/ha.

| Safening | | | |
|---|---|---|---|
| Composition A: | | | |
| (COMMAND | Herbicidal | | |
| 3 ME | Compound: | | |
| HERBICIDE): | Glyphosate | Percent Phytotoxic | |
| Clomazone Rate | Rate of | Injury To Soybean | |
| of Appl'n.: Kg/Ha | Appl'n.: Kg/Ha | Variety A2704 | Variety A3234 |
| 0 | 0 | 0 | 0 |
| 0.25 | 0 | 0 | 0 |
| 0.50 | 0 | 0 | 0 |
| 1.0 | 0 | 0 | 0 |
| 0 | 0.2 | 14 | 22 |
| 0.25 | 0.2 | 1 | 0 |
| 0.50 | 0.2 | 1 | 2 |
| 1.0 | 0.2 | 1 | 1 |
| 0 | 0.4 | 38 | 54 |
| 0.25 | 0.4 | 26 | 28 |
| 0.50 | 0.4 | 16 | 12 |
| 1.0 | 0.4 | 5 | 4 |
| 0 | 0.8 | 60 | 81 |
| 0.25 | 0.8 | 58 | 68 |
| 0.50 | 0.8 | 52 | 65 |
| 1.0 | 0.8 | 37 | 40 |

Without Safening Composition A, the Herbicidal Compound caused significant phytotoxic injury to two varieties of soybean. For example, at the 0.2, 0.4, and 0.8 kg/ha rate of application of Herbicidal Compound, the average injury to the two soybean varieties is about 18%, 46%, and 70%, respectively. Applications of the Safening Composition A containing one or more inorganic, water-soluble salts, and clomazone at a rate of, for example, 1.0 kg/ha, with the Herbicidal Compound reduced the average phytotoxic injury to 1% (94% reduction of injury), 4.5% (90% reduction of injury), and 38.5% (45% reduction of injury), respectively.

### EXAMPLE 2

### Safening of Crops From The Phytotoxic Effects Of The Herbicidal Compound Glyphosate

As set forth in Example 2, the Herbicidal Compound and Safening Composition A were tested in the same manner as described in Example 1. The aforementioned Herbicidal Compound and Safening Composition A were sprayed as a tank mix onto 10-14 day old crop and weed species. The tests were evaluated at 14 days after treatment for percent injury by comparison to tests conducted on untreated plants and weeds, and plants and weeds treated with Herbicidal Compound only.

| Herbicidal | Safening | | | | | | | |
|---|---|---|---|---|---|---|---|---|
| Compound: | Composition | | | | | | | |
| Glyphosate Rate | A: Clomazone | Percent Phytotoxic Injury | | | | | | |
| of Appl'n | Rate of Appl'n | | | Pinto | | | Sorgh | |
| (kg/ha) | (kg/ha) | Cucumber | Corn | Bean | Tomato | Rice | um | Rape |
| 0.2 | 0 | — | — | — | 95 | — | — | — |
| 0.2 | 0.25 | — | — | — | 58 | — | — | — |
| 0.2 | 0.50 | — | — | — | 63 | — | — | — |
| 0.2 | 1 | — | — | — | 56 | — | — | — |
| 0.4 | 0 | 77 | — | 63 | 100 | 65 | 76 | — |
| 0.4 | 0.25 | 36 | — | 41 | 90 | 39 | 53 | — |
| 0.4 | 0.50 | 25 | — | 28 | 95 | 29 | 39 | — |
| 0.4 | 1 | 39 | — | 34 | 60 | 46 | 38 | — |
| 0.8 | 0 | — | 90 | — | — | — | 100 | 84 |
| 0.8 | 0.25 | — | 90 | — | — | — | 86 | 85 |
| 0.8 | 0.50 | — | 69 | — | — | — | 90 | 65* |
| 0.8 | 1 | — | 69 | — | — | — | 71 | 79 |

*Safening only at the clomazone rate of application of 0.50 kg/ha.

Generally, the crops set forth in Example 2 were safened from the phytotoxic effects of the Herbicidal Compound alone by about 23% to by about 61% reduction in phytotoxic injury when Safening Composition A, comprised of at least one inorganic, water-soluble salt, and clomazone, was applied to those crops in admixture with the Herbicidal Compound. For example, when the Herbicidal Compound was applied alone to cucumber at a rate of 0.4 kg/ha, the percent of phytotoxic injury was 77%. When Safening Composition A was applied at a clomazone rate of application of 0.50 kg/ha in admixture with the Herbicidal Compound applied at a rate of 0.4 kg/ha, the percent of phytotoxic injury to cucumber diminished to 25%. The result is about a 60% reduction in phytotoxic injury to this crop species.

### EXAMPLE 3

### Safening of Soybeans From The Phytotoxic Effects Of The Herbicidal Compound Glyphosate

Glyphosate, tested as ROUNDUP® Ultra Herbicide, and at least one plant-safening, inorganic, water-soluble salt (calcium chloride), termed in this example “Safening Composition B”, were tested as water solutions on soybean variety Asgrow 2704. The aforementioned solutions were sprayed onto 12 day-old soybean plants, and the test evaluated in the same manner as described in Example 1.

| Safening | Herbicidal Compound: | Percent |
|---|---|---|
| Composition B: | Glyphosate Rate of | Phytotoxic |
| CaCl₂ Rate of Appl'n.: Kg/Ha | Appl'n.: Kg/Ha | Injury |
| 0 | 0.8 | 70¹ |
| 0.172 | 0.8 | 38 |
| 0.344 | 0.8 | 5 |
| 0.516 | 0.8 | 5 |
| 0 | 0 | 0 |

¹Average of two tests.

Without Safening Composition B, the Herbicidal Compound caused significant phytotoxic injury to soybean. For example, at the 0.8 kg/ha rate of application of Herbicidal Compound, the injury to the soybean is about 70%. Applications of the Safening Composition B containing only calcium chloride at the 0.172 kg/ha rate of application reduced the average phytotoxic injury to 38% (about 46% reduction of injury), whereas the 0.344 kg/ha rate of application and the 0.516 kg/ha rate of application reduced the average phytotoxic injury to 5% (about 93% reduction of injury).

It will be obvious to those of ordinary skill in the art that variations of the invention may be used and that it is intended that the invention may be practiced otherwise than as specifically described herein. Accordingly, this invention includes all modifications encompassed within the spirit and scope of the invention as defined by the following claims.

What is claimed is:

1. A method of protecting a plant from phytotoxic injury from application to a locus thereof of a herbicidally effective amount of at least one N-phosphonomethyl-glycine, which method comprises applying to the locus of said plant said herbicidally effective amount of said N-phosphonomethyl-glycine and prior thereto, together therewith, or subsequent thereto, applying to said locus a safening amount of at least one salt.

2. The method according to claim 1, wherein said at least one salt comprises cations of aluminum, boron, calcium, iron, magnesium, potassium, sodium or zinc.

3. The method according to claim 1, wherein said N-phosphonomethyl-glycine is glyphosate and any of its herbicidally active salts, acids, amides, esters, thioesters and linear and cyclic anhydrides thereof.

4. The method according to claim 1, wherein said salt is at least one of calcium chloride, sodium chloride, potassium chloride, calcium nitrate, sodium nitrate, potassium nitrate, sodium sulfate, aluminum sulfate, ferrous sulfate, magnesium chloride, magnesium sulfate, zinc sulfate, sodium carbonate, or sodium bicarbonate.

5. The method according to claim 4, wherein said salt is at least one of calcium chloride, magnesium chloride, aluminum sulfate, or sodium nitrate.

6. The method according to claim 1, wherein said plant is selected from the group consisting of soybean, cotton, sugarbeet, rape, potato, sunflower, cucumber, pinto bean, tomato, peanut, lettuce, carrot, sweet potato, alfalfa, tobacco, corn, rice, sorghum, wheat, barley, oats, rye, triticale, sugarcane, dried bean and pea.

7. The method of claim 1, further comprising the addition of an herbidically effective amount to said locus of one or more of (2,4-dichlorophenoxy)acetic acid (2,4-D), (4-chloro-2-methylphenoxy)acetic acid (MCPA), (+/−)-2-(4chloro-2-methylphenoxy) propanoic acid (MCPP), isoproturon, imazapyr, imazamethabenz, imazethapyr, imazaquin, bifenox, fomasafen, ioxynil, bromoxynil, chlorimuron, achlorsulfuron, bensulfuron, pyrazosulfuron, triasulfuron, fenoxaprop, fluazifop, quizalofop, diclofop, bentazone, butachlor, metolachlor, acetochlor, dimethenamide, clomazone, sulfentrazone, carfentrazone ethyl, dicamba, fluroxypyr, sulcotrione, mesotrione, isoxaflutole or triclopyr.

8. The method of claim 3, wherein said N-phosphonomethyl-glycine is the isopropylamine salt of glyphosate.

9. A herbicidal composition comprising an herbicidally effective amount of at least one N-phosphonomethyl-glycine and at least one salt; wherein said at least one salt is present in an amount sufficient to safen a plant from phytotoxic injury caused by said at least one N-phosphonomethyl-glycine.

10. The herbicidal composition of claim 9, wherein said plant is soybean, cotton, sugarbeet, rape, potato, sunflower, cucumber, pinto bean, tomato, peanut, lettuce, carrot, sweet potato, alfalfa, tobacco, corn, rice, sorghum, wheat, barley, oats, rye, triticale, sugarcane, dried bean or pea.

11. The herbicidal composition of claim 9, wherein said salt is at least one of calcium chloride, sodium chloride, potassium chloride, calcium nitrate, sodium nitrate, potassium nitrate, sodium sulfate, aluminum sulfate, ferrous sulfate, magnesium chloride, magnesium sulfate, zinc sulfate, sodium carbonate or sodium bicarbonate.

12. The herbicidal composition of claim 11, wherein said salt is at least one of calcium chloride, magnesium chloride, aluminum sulfate or sodium nitrate.

13. The method of claim 3, wherein the amount of glyphosate to said safening amount of at least one salt applied to said locus is in a ratio of 1:0.01-1:100, respectively.

14. The method of claim 3, wherein said salt is calcium chloride and the amount of glyphosate to said safening amount of calcium chloride applied to said locus is in a ratio of 1:0.01-1:20, respectively.

15. The herbicidal composition of claim 9, wherein said N-phosphonomethyl-glycine is glyphosate and any of its herbicidally active salts, acids, amides, esters, thioesters and linear and cyclic anhydrides thereof, said salt is calcium chloride, and the amount of glyphosate to said safening amount of calcium chloride is 1:0.01-1:20, respectively.

16. The herbicidal composition of claim 9, wherein said N-phosphonomethyl-glycine is glyphosate and any of its herbicidally active salts, acids, amides, esters, thioesters and linear and cyclic anhydrides thereof, and the amount of glyphosate to said safening amount of at least one salt is 1:0.01-1:100, respectively.

17. The herbicidal composition of claim 9, wherein said at least one salt comprises cations of aluminum, boron, calcium, iron, magnesium, potassium, sodium or zinc.
